(19) United States
(12) Patent Application Publication
(10) Pub. No.: US 2026/0204982 A1
(43) Pub. Date: Jul. 16, 2026

(54) INTEGRATED AND COMPACT COMBINED HEAT AND POWER SYSTEMS AND RELATED METHODS

(71) Applicant: Enginuity Power Systems, Inc., Alexandra, VA (US)

(72) Inventors: Scott Jorda, Westminster, MD (US); William V. Meyers, JR., Sherwood Forest, MD (US); Steven Niswander, Boyce, VA (US)

(73) Assignee: Enginuity Power Systems, Inc., Alexandria, VA (US)

(21) Appl. No.: 19/315,528

(22) Filed: Aug. 30, 2025

Related U.S. Application Data
(63) Continuation-in-part of application No. 19/016,127, filed on Jan. 10, 2025, now Pat. No. 12,463,259.

(51) Int. Cl. H02K 7/18; F28F 1/00; H02K 11/00

(52) U.S. Cl. CPC H02K 7/1815; F28F 1/00; H02K 11/0094

(57) ABSTRACT

Integrated, relatively lightweight and compact combined heat and power systems supported within a single chassis and related methods are disclosed.

### RELATED APPLICATION

This application is a continuation-in-part of U.S. patent application Ser. No. 19/016,127 filed Jan. 10, 2025 (the “'127 Application”) and incorporates by reference the entirety of the disclosure of the '127 Application as if it were set forth in full herein.

### FIELD

The present disclosure relates generally to an integrated, lightweight and compact combined heat and power (CHP) system that generates, stores and utilizes energy for a variety of applications.

### BACKGROUND

Today there is a continuing challenge to economically provide energy. Furthermore, challenges such as packaging and installation complexity remain as design concerns in the development and adoption of combined heat and power (CHP) systems.

Other challenges include complying with relevant EPA or other state environmental regulatory requirements when providing residential or commercial engines used to power a CHP system. Addressing all of these concerns remains an ongoing challenge.

Accordingly, it is desirable to provide CHP systems and related methods that address the above concerns.

### SUMMARY

The inventors disclose a number of exemplary embodiments that addresses the above concerns, among other concerns.

For example, in one embodiment an integrated. lightweight and compact combined heat and power (CHP) system may be configured on a single chassis and may comprise: a battery compartment comprising one or more batteries; engine compartment comprising an engine; inverter compartment comprising one or more electrical inverters; an electronic control section, and wherein the battery compartment comprising the one or more batteries, the engine compartment comprising the engine, inverter compartment comprising the one or more electrical inverters and the electronic control section are integrated on the single chassis.

In such a system the volume of the system may comprise a volume of four to five in feet in length, two feet wide and four to five feet in height, and the weight of the system may comprise less than 1,000 pounds.

In the exemplary system the battery compartment may comprise four batteries, the engine may comprise a carb-approved engine (e.g., a two cycle or four cycle combustion or compression engine fuel cell, or electrical engine.

Such an exemplary system may be configured to generate eight kilowatts to twenty-five kilowatts of power, for example.

In addition, the exemplary system may further comprise one or more electrical generators for generating electricity at one or more alternating current (AC) power levels.

In an embodiment, the one or more batteries may comprise one or more removable and rechargeable batteries for storing energy as direct current (DC) power, where each of the one or more batteries may be configured to generate 3 to 4 kilowatts of power, for example. Yet further, the one or more batteries may comprise removable and rechargeable batteries.

In an embodiment, the system may further comprise a catalytic converter and one or more internal heat exchanger units for converting heat from heated gas from the engine to a coolant.

In such an exemplary system the single chassis may comprise a chassis constructed of a plurality of vertical supporting columns, where each vertical column is mechanically connected at each of its ends by at least two horizontal arms and a bottom cover. Still further, each column and arm may be composed of a folded steel, aluminum or carbon fiber material, for example.

In such a system the electronic control section may comprise electronics for completing Bluetooth enabled controls for operating the one or more inverters, one or more batteries and the engine, among other components. The control section may be further configured to detect a power level of the one or more batteries, and when the detected power level is below a threshold, the control section may yet be further configured to electrically connect the one or more inverters to the one or more batteries to charge the one or more batteries to a higher power level.

Alternatively, the control section may yet be further configured to detect that a power level of the one or more batteries has reached a pre-determined or set threshold level, and then the control section may be configured to initiate the start-up of the engine in order to recharge the one or more batteries.

In yet another embodiment the system described above may be combined with an exemplary exhaust gas diversion sub-system that is configured to control a flow of heated exhaust gases from the system.

In such an embodiment the exhaust gas diversion sub-system may be configured to receive electrical or mechanical signals to control the flow of heated exhaust gases from the system to completely expel the heated exhaust gases to the atmosphere, or direct the heated exhaust gases to a second heat exchanger in order to further transfer heat or energy from the heated, exhaust gases to a liquid within the second exchanger and to further reduce a temperature of the heated exhaust gases.

The above exemplary embodiments and others are described herein.

### BRIEF DESCRIPTION OF THE DRAWINGS

The disclosure will be described in more detail below on the basis of one or more drawings, which illustrates exemplary embodiments.

FIGS. 1 to 3 depict exterior views of an exemplary integrated and compact CHP system on a single chassis in accordance with an embodiment of the present disclosure.

FIGS. 4 to 6 depict exterior views of an exemplary integrated and compact CHP system on a single chassis with one or more of the exterior covers opened and/or removed in accordance with embodiments of the present disclosure.

FIGS. 7 and 8 depict interior views of an exemplary integrated and compact CHP system on a single chassis with its'covers removed in accordance with an embodiment of the present disclosure.

FIG. 9 depicts an inventive integrated and compact CHP system combined with an exhaust gas diverter system.

FIG. 10A depicts an exhaust gas diversion system that may be used in conjunction with an exemplary integrated and compact CHP system in accordance with an embodiment of the present disclosure.

FIGS. 10B to 10E depict exemplary flows of exhaust gases in an exhaust gas diversion system in accordance with embodiments of the present disclosure.

FIGS. 11A to 11C depict alternative configurations of an exhaust gas diversion system in accordance with an embodiment of the present disclosure.

FIGS. 12A and 12B depict embodiments of a mechanism that is part of an exhaust gas diversion system in accordance with an embodiment of the present disclosure.

FIG. 13A depicts a simplified diagram of another exhaust gas diverter system in accordance with another embodiment of the present disclosure.

FIGS. 13B and 13C depict exemplary enlarged views of positions of a rotatable barrier that is a part of a valve of the exhaust gas diverter system shown in FIG. 13A.

### DETAILED DESCRIPTION OF THE EMBODIMENTS

To the extent that any of the figures or text included or referred to herein depicts or describes dimensions (weights, lengths, widths, heights), operating parameters such as power levels and efficiencies or other operating parameters it should be understood that such information is merely exemplary and non-limiting and, therefore, included to aid the reader in understanding the embodiments described herein. It should be understood, therefore, that such information is provided to enable one skilled in the art to make and use an exemplary embodiment of the disclosure without departing from the scope of the disclosure.

It should be understood that, although specific exemplary embodiments are discussed herein, there is no intent to limit the scope of the present disclosure to such embodiments. To the contrary, it should be understood that the exemplary embodiments discussed herein are for illustrative purposes, and that modified and alternative embodiments may be implemented without departing from the scope of the present disclosure. Exemplary embodiments of CHP systems and related methods are described herein and are shown by way of example in the drawings. Throughout the following description and drawings, like reference numbers/characters refer to like elements.

It should also be noted that one or more exemplary embodiments may be described as a process or method. Although a process/method may be described as sequential, it should be understood that such a process/method may be performed in parallel, concurrently or simultaneously. In addition, the order of each step within a process/method may be re-arranged. A process/method may be terminated when completed and may also include additional steps not included in a description of the process/method if such additional steps are well known in the art.

As used herein, the term “and/or” includes any and all combinations of one or more of the associated listed items. As used herein, the singular forms “a,” “an” and “the” are intended to include the plural form, unless the context and/or common sense indicates otherwise.

As used herein the phrase “configured to” means—functions to—or —connected to—unless the context, common sense or the knowledge of one skilled in the art dictates otherwise.

As used herein, the term “embodiment” and/or “exemplary” refers to an example of the present disclosure.

When used herein the term “lightweight” means a CHP system on a single chassis that is less than 1,000 pounds with four batteries included in the CHP. Compared to existing systems, such a system is relatively lightweight (i.e., weights far less than existing systems that include comparable components).

When used herein the term “compact” means a lightweight CHP system on a single chassis having a volume that does not exceed a maximum volume. By “maximum volume” is meant a lightweight CHP system on a single chassis having a volume that does not exceed an approximate volume equal to an approximate length of no more than six feet, an approximate width of no more than three feet and an approximate height of no more than six feet (e.g., four to five in feet, two feet wide and four to five feet in height).

When used herein the term “integrated” means all of the elements of a lightweight, compact CHP system 1 are supported by a single chassis as compared to existing systems that are on multiple chassis.

When used herein the phrase “carb-approved” means at least an engine that meets or exceeds the emission standards set by the California Air Resources Board.

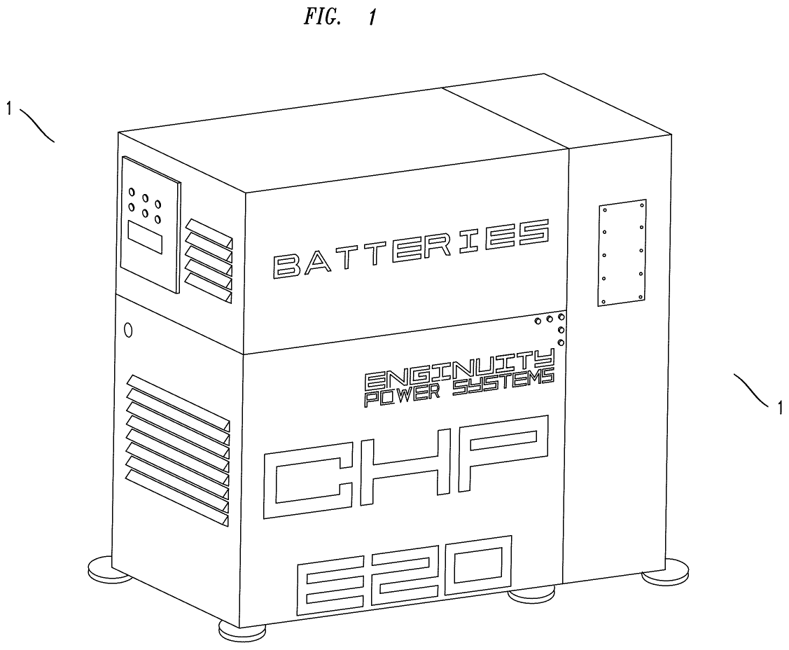

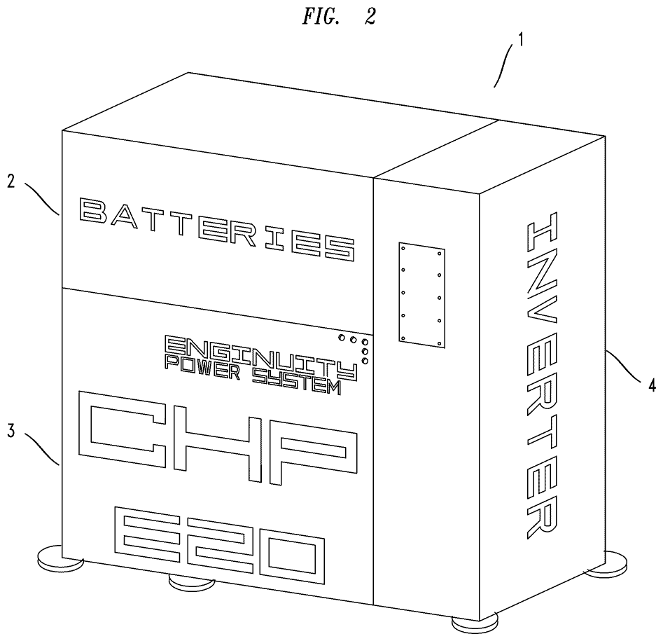

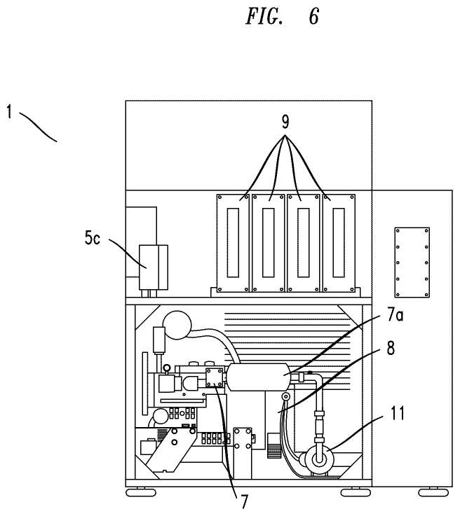

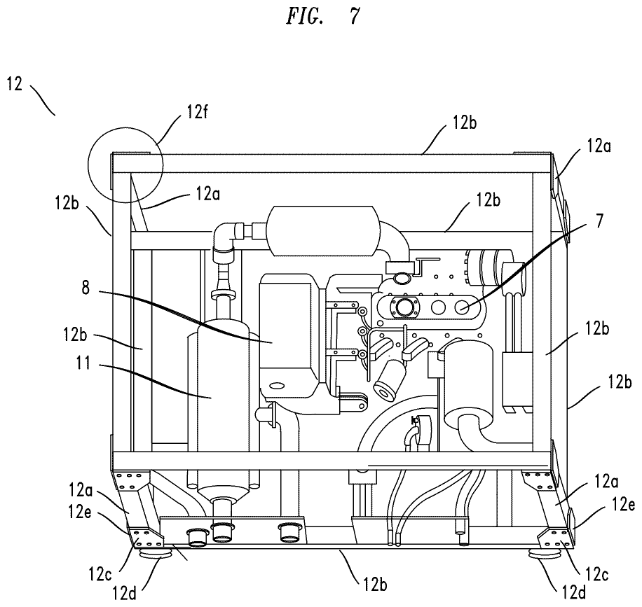

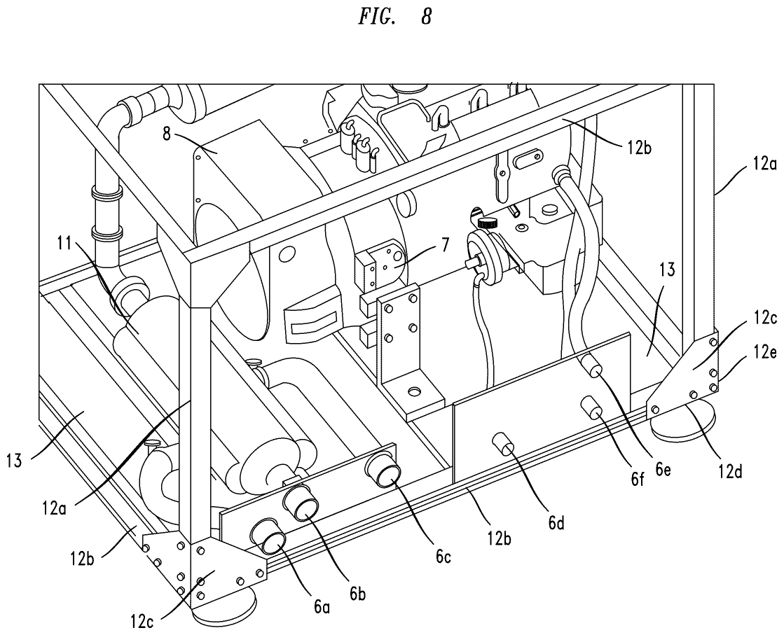

Referring to FIGS. 1 to 3 there are depicted exterior views of an exemplary integrated. lightweight and compact CHP system 1 on, and connected to, a single chassis according to an embodiment of the disclosure (the chassis 12 is shown in FIGS. 7 and 8).

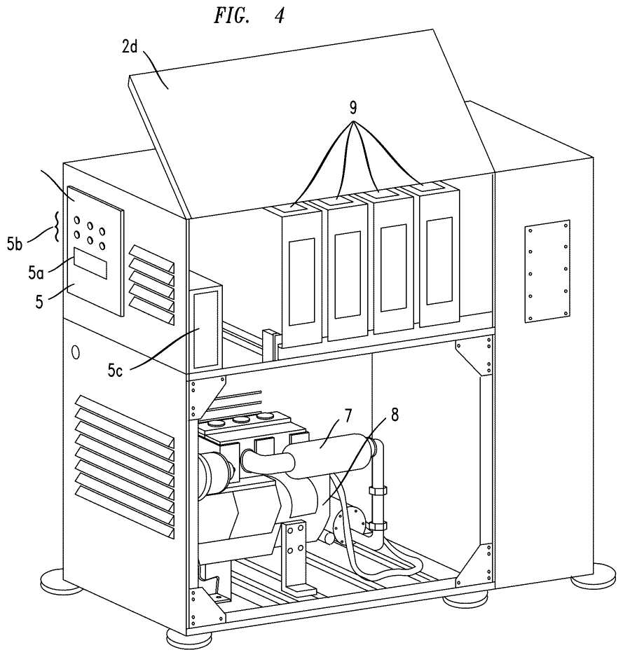

As depicted, the CHP system 1 may be configured to include a battery compartment 2 comprising one or more electrical batteries, engine compartment 3 and an inverter compartment 4 comprising one or more electrical inverters, though it should be understood that the positions of each of the compartments on the single chassis may change depending on size or technical requirements, provided however, that all of the compartments remain on the single chassis. Size-wise, the overall dimension of the system may be four to five in feet in length (L), two feet wide (W) and four to five feet in height (H). Individually, as a non-limiting example, the CHP compartment may measure four in feet in length, two feet wide and three feet in height, for example. Weight-wise, the overall system may be considered “lightweight” compared to existing, non-integrated systems that include an engine, generator, batteries and a local control section because the system 1 may weigh less than 1,000 pounds with four batteries 9 installed in the battery compartment, for example (see batteries 9 in FIG. 4).

Power-wise, the system 1 may be configured to provide eight kilowatts to twenty-five kilowatts of power with, again, four batteries 9 installed. That said, the more batteries that are included in the system 1 the higher the power output such that the eight to twenty five kilowatts of power is merely a non-limiting range of power.

Because all of the elements of the system 1 are on a single chassis as compared to existing systems that are on multiple chassis the system can be said to be integrated on a single chassis. Further, because all of the elements of the system 1 are configured and connected to fit on a single chassis having a volume that does not exceed a maximum volume as described further herein, the system can be said to be compact as compared to existing systems that require more than one chassis, or a very large chassis compared to the inventive chassis (see element 12 in FIG. 7).

Still further, the installation of the integrated. lightweight and compact system 1 is greatly simplified versus existing systems that require multiple elements to be individually installed and then connected together in order to operate as a system.

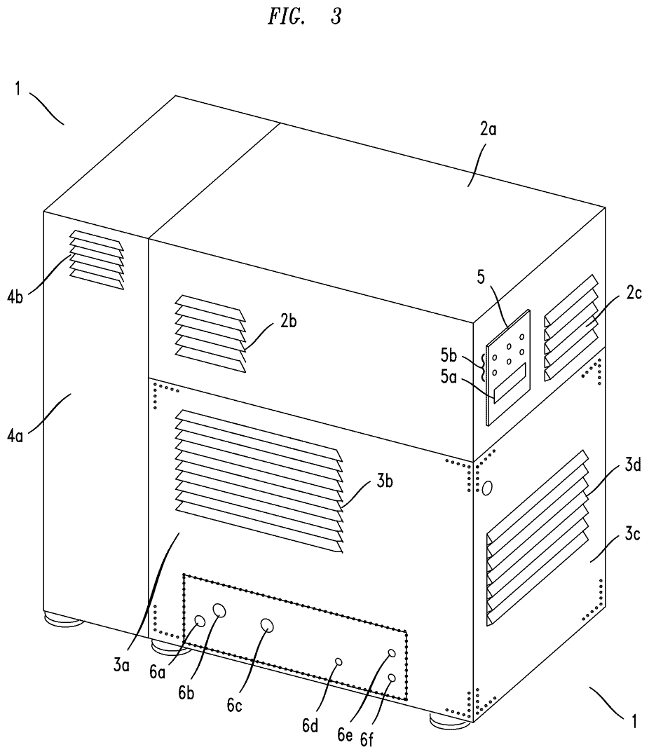

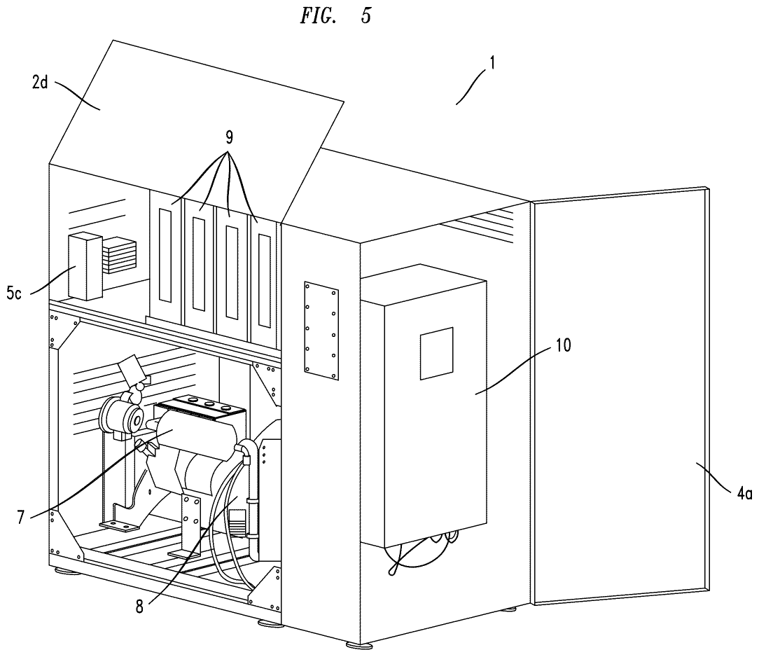

Referring more particularly to FIG. 3 there is depicted a more detailed exterior view of the system 1. In an embodiment, the integrated, lightweight and compact system 1 may comprise: an external inverter cover 4a that includes one or more inverter ventilation openings 4b to allow air to circulate into the system 1 and cool the one or more electrical inverters (see component labeled 10 in FIG. 5) within the inverter compartment; an external battery cover 2a and one or more battery ventilation openings 2b,2c to allow air to circulate into the system 1 and cool the one or more batteries (see components labeled 9 in FIGS. 4 to 6); external CHP covers 3a,3c, each of which may include one or more engine ventilation openings 3b, 3d to allow air to circulate into the system 1 and cool the one or more components of the engine compartment (see components labeled 7, 8 and 11 in FIGS. 4 to 8). Though only exterior covers 2a, 3a, 3c and 4a are shown in FIG. 3 it should be understood that each side and the top of the system 1 may include an exterior cover, for example.

Also depicted in FIG. 3 is an exemplary control section 5 that may include an electronic display 5a configured to display information about the operation of the system 1 (e.g., alerts, temperatures, battery life, voltages, etc.,) that is connected to the cover 2a by one or more fasteners 5b. Also shown are inputs/outputs 6a to 6f (see also FIG. 8) discussed below.

Referring now to FIG. 4 there is depicted another exterior view of the integrated, lightweight and compact system 1 on a single chassis with one or more of the exterior covers open and/or removed (e.g., battery cover 2d is open) in accordance with an embodiment of the present disclosure. As depicted, within the interior of the exemplary CHP system 1 there may be positioned one or more carb-approved engines or fuel cells 7 within the engine compartment 3 (e.g., two or four cycle combustion or compression engines, electrical engines) for generating power, one or more electrical generators 8 for generating electricity at one or more alternating current (AC) power levels (120 volts. 240 volts) and one or more removable and rechargeable batteries 9 (i.e., battery pack composed of, for example, lead-acid, nickel-cadmium, lithium-ion nickel metal hydride or solid state materials) for storing energy as direct current (DC) power and providing energy to the system 1 (e.g., to start the engine 7) and/or to an external building or residential home, for example. In an embodiment, each battery 9 may provide 3 to 4 kilowatts of power (e.g., 3.3 kilowatts per battery 9) and may weigh approximately 30 pounds though these are merely non-limiting, exemplary power and weight parameters. Further, though FIG. 4 depicts four removable and rechargeable batteries 9 this is also a non-limiting example. Fewer batteries (e.g. one to three) or more batteries (e.g., up to twenty) may be added to the system 1.

Though only a single engine 7 and generator 8 are shown in FIG. 4, this is also merely exemplary. In alternative embodiments the integrated, lightweight and compact system 1 may include a plurality of generators and/or engines (e.g., two engines, two to four or more generators).

Referring now to FIG. 5 there is depicted yet another exterior view of the CHP system 1 on a single chassis with one or more of the exterior covers open and/or removed (e.g., battery cover 2d and inverter cover 4a are open or removed) in accordance with an embodiment of the present disclosure.

Similar to FIG. 4, within the interior of the exemplary integrated, lightweight and compact system 1 there may be positioned the same components on the same single chassis, namely: one or more engines 7 for generating power, the same one or more electrical generators 8 for generating electricity at AC power levels (referred to in the singular hereafter as “generator” though there may be a plurality of generators), and the same one or more batteries 9 for storing energy as DC power and providing energy to the system 1 (may be referred to in the singular hereafter as “battery” though there may be a plurality of batteries) and/or to an external building or residential home, for example. In addition, FIG. 5 depicts one or more inverters 10 (referred to in the singular hereafter as “inverter” though there may be a plurality of inverters) for transforming and inverting the AC power level generated by the one or more generators 8 into one or more DC power levels and then back (inversion) to one or more, reduced-noise AC power levels.

Also shown in FIG. 5 is a battery temperature control unit 5c which may comprise a temperature sensor and fan (not shown), for example. In an embodiment, the unit 5c may be configured to monitor the temperature of the batteries 9 and when the temperature exceeds a preset threshold the unit 5c may cool the batteries by sending a signal to an integral fan motor that is configured to move the fan which forces air over the batteries 9 in order to reduce the temperature of the batteries 9.

Referring now to FIG. 6 there is depicted still another exterior view of the system 1 on a single chassis with one or more of the exterior covers open and/or removed (e.g., battery cover 2d and inverter cover 4a are again open or removed) in accordance with an embodiment of the present disclosure. As shown, this view again depicts an exemplary position for the one or more batteries 9, engine 7 and generator 8. In addition, this view includes a view of the catalytic converter 7a, one or more internal heat exchanger units 11 (referred to in the singular hereafter as “unit” though there may be a plurality of units). In an embodiment, heated gas from the engine 7 may be exhausted through the heat exchanger unit 11. The passage of the heated gas through the unit 11 increases the temperature of the unit 11. Further, heat from the heated gas (i.e., unit 11) may be transferred to a coolant, such as a glycol or water, that comes into contact with the unit 11 via interior piping within the system 1 (see FIG. 8). The heated water may be transported via the interior piping to external piping and then to a building or residential home for usage.

Still further, the internal heat exchanger unit 11 may be configured to muffle or reduce the sound level of the exhaust gas that is being output from the system 1.

Referring now to FIG. 7 there is depicted an interior view of the exemplary integrated and compact CHP system 1 on a single chassis 12 with its'covers and batteries 9 removed in accordance with an embodiment of the present disclosure. With its covers removed the reader can clearly see the exemplary positions and configuration of the engine 7, engine components, generator 8 and heat exchanger unit 11. As shown, the chassis 12 may be constructed of: (i) a plurality of vertical supporting columns 12a, each vertical column 12a being mechanically connected at each of its ends (i.e., top end and bottom end) by (ii) at least two horizontal arms 12b and (iii) bottom cover 13. Further, at the connection of each column 12a and arm 12b the chassis 12 may also include a reinforcement plate 12c (e.g., triangular shaped plate). In an embodiment, the base 12d of a plate 12c may be connected to an arm 12b while the altitude 12e of the plate 12c may be connected to a column 12a. In an embodiment each corner 12f of the chassis 12 may comprise two plates 12c.

In embodiments, each column 12a and arm 12b may be composed of a folded steel, aluminum or carbon fiber material to name just a few of the lightweight materials making up the components of the chassis 12.

FIG. 8 also depicts an interior view of the exemplary integrated and compact CHP system 1 on a single chassis 12 with its'covers and batteries 9 removed. In this view, inputs and outputs 6a to 6f are also clearly shown. In an embodiment, the inputs/outputs may comprise the following: exhaust outlet 6b for transporting and outputting exhaust gas produced by operation of the engine 7 to the atmosphere; water outlet 6a for transporting hot water that has been heated by the heat exchanger 11 to piping (not shown) that leads to a building, residential house or simply to a storage system (e.g., hot water tank); water inlet 6c for transporting cold, cooler (as compared to the heated water) or room temperature water from an external source (e.g., piping from a building, residential home or from a tank) to the heat exchanger 11 to be warmed by the heat exchanger 11; fuel inlet 6d for transporting fuel such as gasoline or diesel to name just two of the many types of liquid fuel to the engine 7; coolant outlet 6e for transporting heated coolant from the engine 7; and coolant inlet or return 6f for transporting coolant to the engine 7 to cool the engine 7.

In slightly more detail, the heat exchanger 11 may be configured with a liquid jacket 11a positioned at two sides of the circumference of the exhaust section 11b of the exchanger 11. In an embodiment, heated exhausted gas within section 11b raises the temperature of the liquid (e.g., glycol, water) within the jacket 11a. Thereafter, the heated liquid may be transported to an external destination via outlet 6a, for example.

Backtracking somewhat, in an embodiment the control section 5 may comprise suitable electronics for completing Bluetooth enabled controls for operating components of the system 1, such as the inverter 10, generator 8, batteries 9 and engine 7.

Optionally, the chassis 12 may be provided with wheels for moving the system 1 if repairs need to be completed, for example.

In an embodiment, during operation of the integrated and compact CHP system 1 energy may initially be supplied to a home or business by the one or more batteries 9 that has been previously charged by the combination of the engine 7 and the inverter 10. When the control section 5 detects that the power level of the batteries 9 are (is) below a threshold, the control section 5 may send an electronic signal to a switch (not shown) that connects the inverter 10 to the batteries 9 in order to charge the batteries 9 to a higher power level.

Said another way, the control section 5 may be configured to detect a power level of the one or more batteries 9, and when the detected power level is below a threshold, the control section 5 is further configured to electrically connect the one or more inverters 10 to the one or more batteries 9 to charge the one or more batteries 9 to a higher power level, for example.

However, once the control section 5 and associated sensors (not shown) detect that the energy level of the batteries 9 has reached a certain pre-determined or set threshold level (e.g., 30% or less of battery life remains) electronics within the control section 5 may generate and send signals to the engine 7 to initiate the start-up of the engine 7 in order to recharge the batteries 9.

Said another way, the control section 5 may be further configured to detect that the power level of the one or more batteries 9 has reached a pre-determined or set threshold level. Thereafter the control section 5 may be further configured to initiate the start-up of the engine 7 in order to recharge the one or more batteries 9.

The control section 5 may comprise temperature controls that are operable to control the “on” and “off” supply of heated liquid from the heat exchanger 11. In more detail, in one embodiment electronics within the control section 5 (sometimes referred to as “control electronics”) may be connected via wired or wireless means to switches or sensors (not shown) operable to detect signals from an external source, such as a water tank, that is requesting heated water. If such a signal indicates water is needed (e.g., an ON signal), then the control electronics may generate and send signals to heat exchanger 11 to allow water to be input via inlet 6c, heated by the heat exchanger 11 and then output via outlet 6a.

Conversely, once water is no longer needed, such switches or sensors may send an OFF signal to the control section 5 that, in turn, send signals to the heat exchanger 11 to prevent water from being output.

In an embodiment, the removable and rechargeable batteries 9 may provide a range of power. As noted previously, one non-limiting range may be 3 to 4 kilowatts of power, for example. Further, the batteries 9 may be removable batteries thus allowing one or more of the batteries 9 to be removed from the chassis 12 should the original batteries 9 fail or need to be otherwise replaced in order to allow a new or substitute battery to be installed into the system 1.

In an embodiments, when used to supply power (i.e., electricity) one or more of the batteries 9 may be configured to supply power to a home or building while another of the batteries 9 may be separately configured to start the engine 7, for example. Alternatively, the one or more of the same batteries 9 may be configured to supply power to a home and business and also start the engine 7.

In yet another embodiment the electronics in the control section 5 (see FIG. 3) may be configured to generate control signals based on electronic instructions stored in an electronic memory (not shown) to control the operation of the batteries 9 in order to allow energy stored in one or more of the batteries 9 to be sent or otherwise transmitted back to an existing power grid as desired or required. Still further, in an embodiment, a utility may install controls (not shown in figures) that permit the utility to request and receive energy stored within integrated CHP system 1 as needed. For example, it is known that many utilities must pay (other utilities, or energy source providers) a substantial premium to supply electrical energy to residential and commercial customers during “peak” energy time periods (e.g. when everyone turns their air conditioners on over the same time period during the summer months). This premium may amount to 25% or more of a utilities'yearly cost of providing electricity. In contrast, the embodiments of the present disclosure —hen combined with required controls—allows such a utility to request and receive additional power from the system 1 instead of another utility at a lower cost.

Embodiments of the disclosure may lower a utility's cost of producing electricity in yet another way. For example, it is known that a substantial amount of energy from an energy source (coal) is lost between the time the energy source is used by a utility to generate electricity at an operating plant and the time the energy is actually delivered to a remote customer. By some estimates, 65% of the energy generated is lost by the time it is delivered to a customer's traditional heating and electrical system. In comparison, systems provided by the disclosure, such as system 1, installed at a location where the heat and electricity will be utilized have the capability of delivering approximately 60% more energy than traditional heating and electrical systems.

Referring now to FIG. 9 there is depicted an exemplary installation of an inventive system 14 that combines CHP system 1 with an exhaust gas diversion sub-system 15 (components within the dotted line of FIG. 9, excluding CHP system 1) that may be installed external to a residence or building, for example.

In an embodiment, the exhaust gas diversion sub-system (EGDS) 15 may be configured to control the flow of heated exhaust gases from CHP system 1. For example, the EGDS 15 may comprise an electro-mechanical diverter mechanism 15A configured to receive electrical or mechanical signals which control the flow of heated exhaust gases from the CHP system 1 in order to (1) completely expel the heated, exhaust gases to the atmosphere, and/or (2) direct the heated, exhaust gases to a second heat exchanger 16 in order to further transfer heat or energy from the heated, exhaust gases to a liquid within the exchanger 16 and to further reduce the temperature of the heated exhaust gases. For example, the temperature of the exhaust gas leaving the CHP system 1 at point T₁ in FIG. 9 may be 1300 degrees Fahrenheit while the temperature of the exhaust gas leaving the second heat exchanger 16 at point T₂ may be 150 degrees Fahrenheit to give some exemplary temperatures.

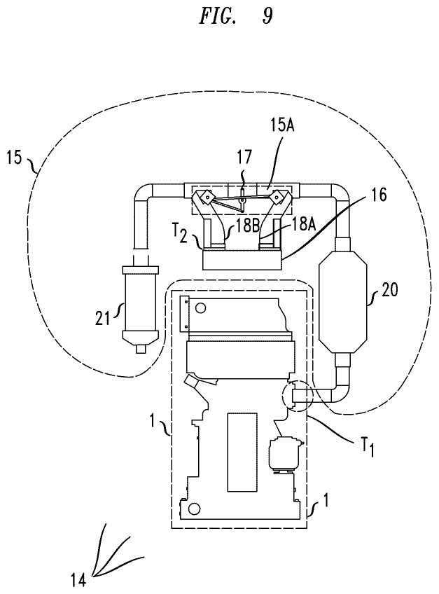

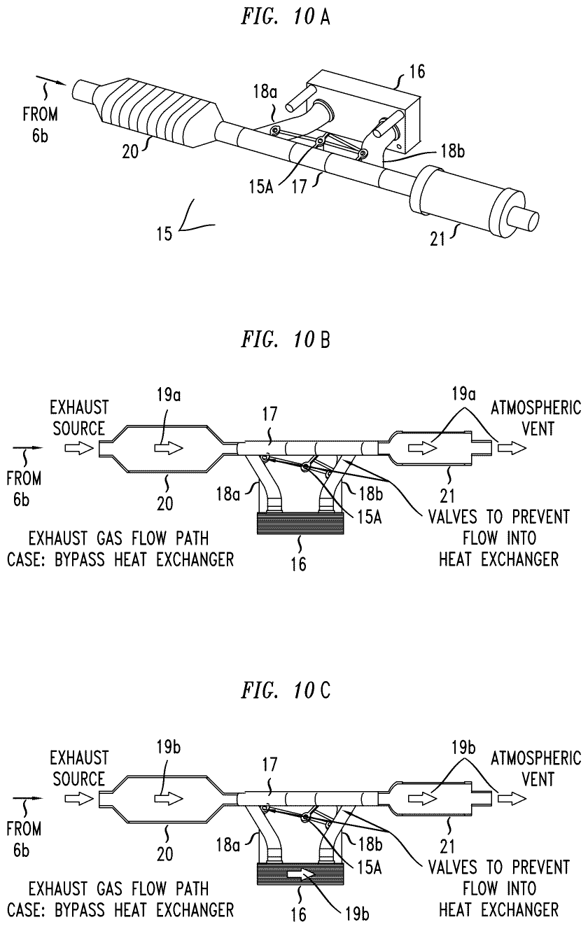

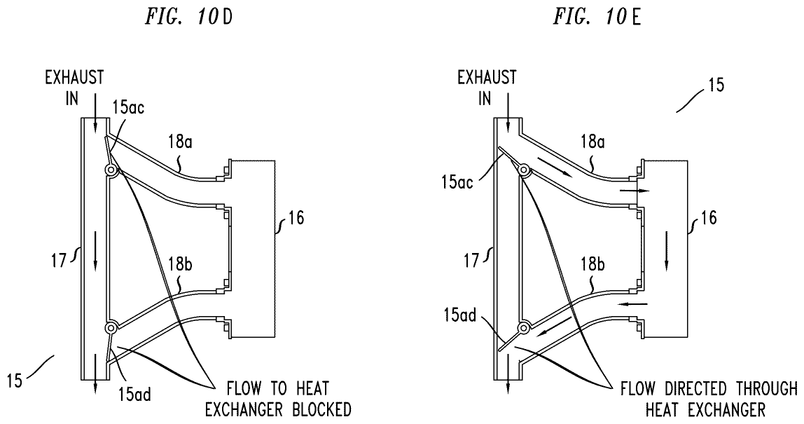

Referring now to FIG. 10A there is depicted an enlarged view of the EGDS sub-system 15 and second heat exchanger 16. The exemplary configuration shown in FIG. 10A also includes a second catalytic converter 20 positioned inline of the exhaust gases and before (on input piping 18a) and, the second heat exchanger 16 and a muffler 21 positioned inline of the exhaust gases and after (on output piping 18b) the second heat exchanger 16. Further, the configuration in FIG. 10A includes a connecting through-pipe 17 positioned inline of the exhaust gases that connects the input side to the output side of the second heat exchanger 16.

In an embodiment the second heat exchanger 16 may comprise an air-to-liquid heat exchanger where heated exhaust gases from the outlet 6b of CHP system 1 are input via piping 18a and subsequently transfer heat to a liquid (e.g., water) within internal coils, piping or radiators (not shown) of the exchanger 16 thereby increasing the temperature of the liquid within the exchanger 16 and decreasing the temperature of the exhaust gases. The warmed or heated liquid within the second heat exchanger 16 may be transported via piping to a residence or building (not shown) for usage (e.g., heated flooring, radiator heating) or storage (e.g., in a hot water tank).

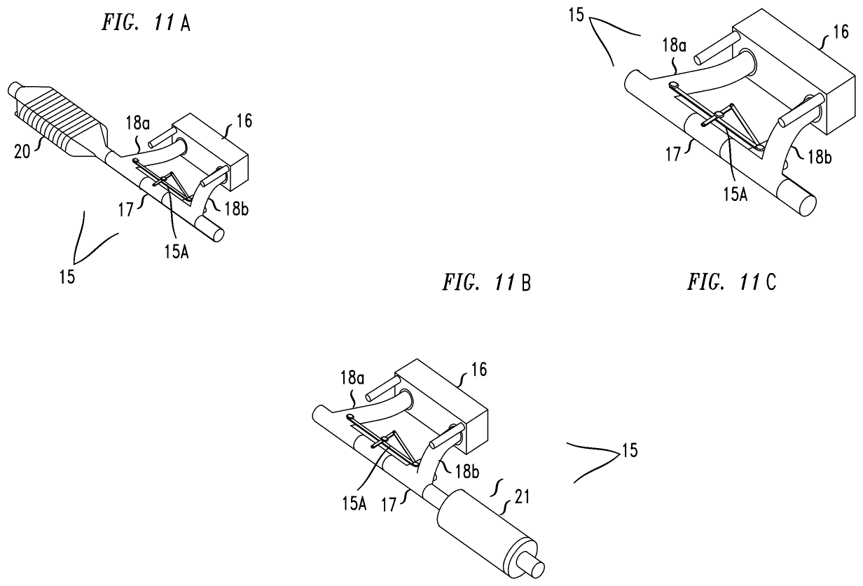

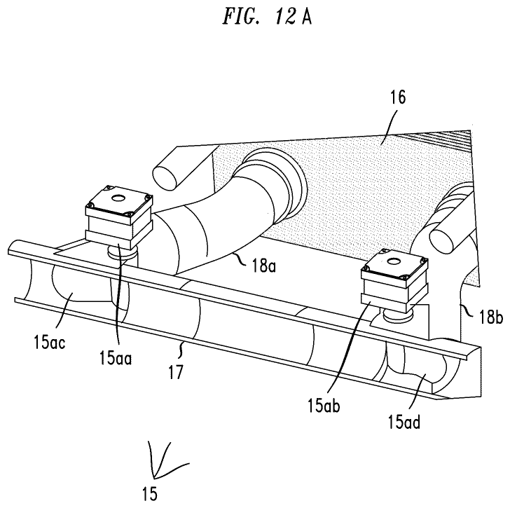

It should be noted that the configuration shown in FIG. 10A is one of many different configurations. FIGS. 11A to 11C depict additional configurations of an exhaust gas diversion sub-system which include (i) a second catalytic converter 20, but no muffler (FIG. 11A), (ii) a muffler 21, but no second catalytic converter (FIG. 11B) and (iii) no second catalytic converter and muffler (FIG. 11C).

FIGS. 10B to 10E depict exemplary flows of exhaust gases in an exhaust gas diversion sub-system 15 depending on whether or not the mechanism 15A allows the exhaust gases to flow to the second heat exchanger 16.

For example, in the configuration of depicted in FIGS. 10B and 10D the mechanism 15A has prevented the exhaust gases from flowing to the second heat exchanger 16 while in FIGS. 10C and 10E the mechanism 15A has allowed the exhaust gases to flow to the second heat exchanger 16.

In slightly more detail, in the embodiment depicted in FIG. 10B the mechanism 15A has received electrical, electronic or electro-mechanical control signals from a control unit (not shown; but see component 5) that direct diverters within piping 18a and 18b to prevent exhaust gases 19a from flowing into (or out of) the second heat exchanger 16. Similarly, in the embodiment depicted in FIG. 10C the mechanism 15A has received electrical, electronic or electro-mechanical control signals from a control unit (not shown) that direct diverters within piping 18a and 18b to allow exhaust gases 19b to flow into (and out of) the second heat exchanger 16.

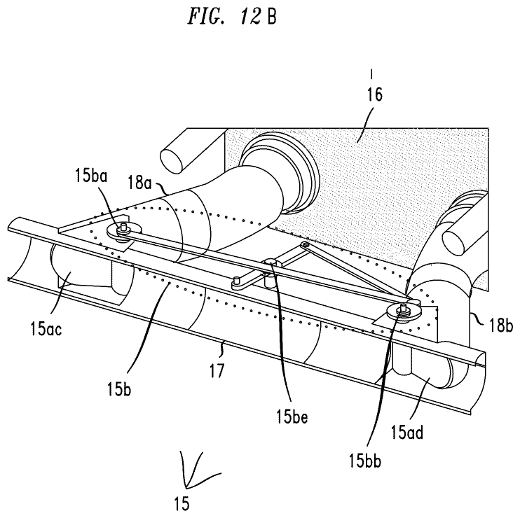

Referring now to FIGS. 12A and 12B there are depicted embodiments of the mechanism 15A.

In FIG. 12A the mechanism 15A may comprise one or more electronic actuators 15aa, 15ab. As shown in FIG. 12A, in one embodiment a separate actuator 15aa may be configured at the input of the second heat exchanger 16, for example at the connection of the input piping 18a to an end of the through piping 17 and another (second) separate actuator 15ab may be positioned at the output of the second heat exchanger 16, for example at the connection of the output piping 18b to an opposite end of the through piping 17. To allow exhaust gases to flow into and out of the second heat exchanger 16 the actuators 15aa,15ab may receive electrical, electronic or electro-mechanical control signals from a control unit (not shown).

In more detail, upon receiving such a control signal at actuator 15aa an internal motor within actuator 15aa may energized in order to move diverter 15ac to a position that allows exhaust gases to flow into the exchanger 16 via piping 18a by blocking the exhaust gases from flowing into through piping 17. Similarly, upon receiving such a control signal at actuator 15ab an internal motor within actuator 15ab may energized in order to move diverter 15ad to a position that allows exhaust gases to flow from the exchanger 16 via piping 18b by blocking the exhaust gases from flowing backwards towards actuator 15ab via through piping 17.

In FIG. 12B the mechanism 15A may comprise a mechanical linkage structure 15b comprising one or more linkage arms 15c and movable hinges 15ba, 15bb and 15bc. As shown in FIG. 12B, in one embodiment a first hinge 15ba may be configured at the input of the second heat exchanger 16, for example at the connection of the input piping 18a to an end of the through piping 17 and another (second) separate hinge 15bb may be positioned at the output of the second heat exchanger 16, for example at the connection of the output piping 18b to an opposite end of the through piping 17. A third hinge 15bc (“master hinge’) may be connected to the center of the mechanism 15b.

To allow exhaust gases to flow into and out of the second heat exchanger 16 the master hinge 15bc may receive electrical, electronic or electro-mechanical control signals from a control unit (not shown; but see component 5) or may be moved manually by a person. For example, in one embodiment upon receiving such a control signal hinge 15bc may move thereby causing the arms 15c to move which, in turn, causes connected hinges 15ba and 15bb to turn.

Once hinge 15ba turns it causes connected diverter 15ac to turn to a position that allows exhaust gases to flow into the exchanger 16 via piping 18a by blocking the exhaust gases from flowing into through piping 17. Similarly, once hinge 15bb turns it causes connected diverter 15ad to turn to a position that allows exhaust gases to flow from the exchanger 16 via piping 18b by blocking the exhaust gases from flowing backwards towards hinge 15ba via through piping 17.

The configurations shown in the figures and described above are just some of the embodiments made possible by the present disclosure—others are possible

For example, in yet an additional embodiment, the second heat exchanger 16 may be connected to a pump (not shown) that forces liquid that has been heated by the exhaust gases into a set of pipes buried underground where the temperature of the ground is cooler than the atmosphere (e.g., 55 degrees Fahrenheit). Accordingly, the heated liquid may be transported through the buried pipes where it is cooled. The now cooled liquid may then be transported via additional piping to an air handler (not shown in figures) where fans may force air over the additional piping containing the cooled liquid. Upon traveling over (or through) the cooled piping the air from the fans is cooled and, thereafter, may be transported through conduits into the building or residence to cool the air therein (i.e., to provide air conditioning).

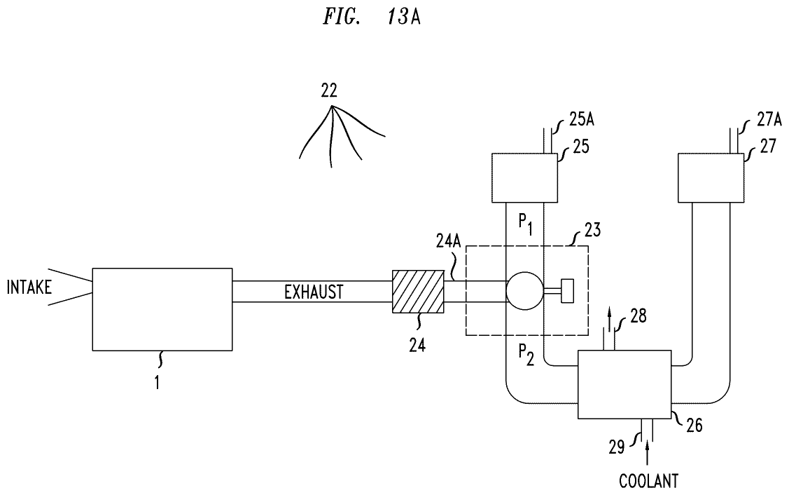

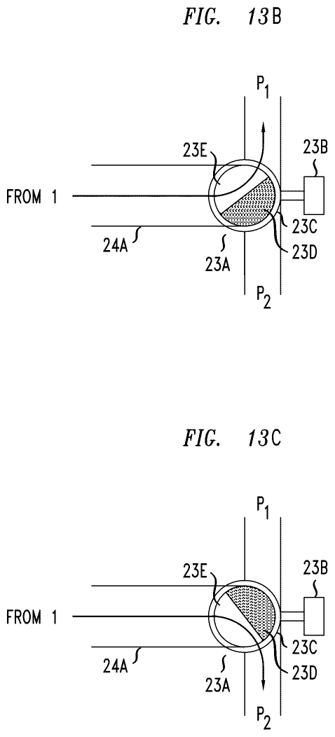

FIGS. 9 to 12B are just one example of an inventive system 14 that includes an EGDS. For example, FIGS. 13A to 13C depict another exemplary system 22 that includes another EGDS 23 in accordance with the disclosure.

Referring first to FIG. 13A there is shown a simplified diagram of the system 22 that combines CHP system 1 with another exemplary exhaust gas diversion sub-system 23.

In an embodiment, as a hot exhaust is expelled from the system 1 it travels to a catalytic converter 24 which may be the same as the second catalytic converter 20 mentioned earlier. Upon being treated by the converter 24 the gases exit and are then fed to the EGDS 23 via piping or tubing 24A.

In an embodiment, EGDS 23, as with EGDS 15, may be configured to receive electrical and/or mechanical signals to control the flow of heated exhaust gases from the system 1 to completely expel the heated exhaust gases to the atmosphere (e.g., via first muffler 25 and exhaust pipe 25A), or direct the heated exhaust gases to another heat exchanger 26 in order to further transfer heat or energy from the heated, exhaust gases to a liquid within the heat exchanger 26 and to further reduce a temperature of the heated exhaust gases before being expelled (e.g., via second muffler 27 and exhaust pipe 27A),

In an embodiment, the heat exchanger 26 may be configured to also receive electrical and/or mechanical signals in order to (i) output heated water or another liquid via outlet 28, (ii) expel cooled gases to the second muffler 27 and/or (iii) receive coolant via inlet 29.

While FIG. 13A depicts two separate mufflers 25,27 and exhaust pipes 25A,27A in yet another embodiment one muffler and exhaust pipe may be used if the two paths P₁ and P₂ shown in FIG. 13A are combined into one path before their respective gases reach a muffler, for example.

Still further, it should be understood that the inclusion of one or more mufflers is optional and may depend on the application or use (i.e., sound attenuation requirements).

In an embodiment, the EGDS 23 may comprise a valve 23A as shown in FIGS. 13B and 13C.

FIGS. 13B and 13C depict exemplary enlarged views of positions of a rotatable barrier 23D that is a part of the valve 23A. In an embodiment the EGDS 23 may comprise the valve 23A and a drive mechanism and/or actuator 23B (e.g., a motor and spindle) connected to the valve 23A, for example.

The valve 23A may further comprise an outer housing or casing 23C that may surround the rotatable barrier 23D and has an opening or port 23E. In one embodiment the outer housing or casing 23C may also be rotatable.

Still further, the valve 23A may include a liquid cooling jacket or section to further reduce the heat or energy of the gases from the system 1. In such a configuration the jacket may be configured with one or more outlets and inlets in order to transport (or receive) heated or cooled liquid to/from another part of the system 1, such as transporting a heated liquid to other portions of the system 1 which in turn functions to warm other components of the system 1.

In FIG. 13B exhaust gas from the system 1 enters the valve 23A via port 23E and is directed to enter pathway P₁ because the barrier 23D has been rotated by the actuator or drive mechanism 23B to block the gases from entering pathway P₂.

Said another way, in an embodiment the drive mechanism or actuator 23B may be configured to receive electrical and/or mechanical signals and rotate the barrier 23D to a first position to block the flow of gases from entering the second pathway P₂ to completely expel the heated exhaust gases to the atmosphere via the first pathway P₁.

By contrast, in FIG. 13C exhaust gas from the system 1 enters the valve 23A via port 23E and is directed to enter pathway P₂ because the barrier 23D has been rotated by the actuator and/or drive mechanism 23B to block the gases from entering pathway P₁.

Said another way, in an embodiment the drive mechanism or actuator 23B may be configured to receive electrical and/or mechanical signals and rotate the barrier 23D to a second position to block the flow of gases from entering the first pathway P₁ to direct the heated exhaust gases to the other heat exchanger 26 via the second pathway P₂ and to further reduce a temperature of the heated exhaust gases before being expelled.

It should be understood that the preceding is merely a detailed description of various embodiments of the disclosure and that numerous changes to the disclosed embodiments can be made in accordance with the disclosure herein without departing from the scope of the disclosure. The preceding description, therefore, is not meant to limit the scope of the disclosure. Rather, the scope of the disclosure is to be determined only by the appended claims and their equivalents.

We claim:

1. An integrated power generation system on a single chassis comprising:
one or more batteries;
an engine and one or more internal heat exchanger units for converting heat from heated gas from the engine to a heat exchange fluid;
one or more electrical inverters;
an electronic control section, and
wherein the one or more batteries, the engine, the one or more electrical inverters and the electronic control section are integrated on the single chassis.

2. The system as in claim 1 wherein the system is configured to generate eight kilowatts to twenty-five kilowatts of power.

3. The system as in claim 1 wherein the engine comprises a carb-approved engine or fuel cell.

4. The system as in claim 3 wherein the carb-approved engine comprises a two cycle or four cycle combustion or compression engine.

5. The system as in claim 1 further comprising one or more electrical generators for generating electricity at one or more alternating current (AC) power levels.

6. The system as in claim 1 wherein the one or more batteries comprises one or more removable and rechargeable batteries for storing energy as direct current (DC) power.

7. The system as in claim 1 wherein each of the one or more batteries is configured to generate 3 to 4 kilowatts of power.

8. The system as in claim 1 wherein the one or more batteries comprise removable and rechargeable batteries.

9. The system as in claim 1 further comprising a catalytic converter.

10. The system as in claim 1 wherein the electronic control section comprises electronics for completing Bluetooth enabled controls to operate the one or more inverters, one or more batteries and the engine.

11. The system as in claim 1 wherein the control section is configured to detect a power level of the one or more batteries, and when the detected power level is below a threshold, the control section is further configured to electrically connect the one or more inverters to the one or more batteries to charge the one or more batteries to a higher power level.

12. The system as in claim 1 wherein the control section is configured to detect a power level of the one or more batteries has reached a pre-determined or set threshold level, the control section is further configured to initiate the start-up of the engine in order to recharge the one or more batteries.

13. The system as in claim 1 further comprising an exhaust gas diversion sub-system configured to control a flow of heated exhaust gases from the system.

14. The system as in claim 1 further comprising an exhaust gas diversion sub-system comprising a drive mechanism or actuator configured to receive electrical and/or mechanical signals and rotate a barrier to,
a first position to block the flow of gases from entering a second pathway to completely expel heated exhaust gases to the atmosphere via a first pathway, or
a second position to block the flow of gases from entering the first pathway to direct the heated exhaust gases to another heat exchanger via the second pathway and to further reduce a temperature of the heated exhaust gases before being expelled.

15. A method for providing energy comprising:
integrating a power generation system on a single chassis, wherein the system comprises one or more batteries, one or more electrical inverters, an engine, an electronic control section and one or more internal heat exchanger units for converting heat from heated gas from the engine to a heat exchange fluid.

16. The method as in claim 15 further comprising generating eight kilowatts to twenty-five kilowatts of power from the system.

17. The method as in claim 15 further comprising generating electricity at one or more alternating current (AC) power levels from one or more electrical generators included in the system.

18. The method as in claim 15 further comprising generating 3 to 4 kilowatts of power.

19. The method as in claim 15 further comprising completing Bluetooth enabled controls to operate the one or more inverters, one or more batteries and the engine.

20. The method as in claim 15 further comprising detecting a power level of the one or more batteries has reached a pre-determined or set threshold level and initiating the start-up of the engine for recharging the one or more batteries.
